(19) United States
(12) Patent Application Publication
(10) Pub. No.: US 2024/0203195 A1
(43) Pub. Date: Jun. 20, 2024

(54) GAMING MACHINE, GAMING METHOD, AND STORAGE MEDIUM

(71) Applicant: Konami Gaming, Inc., Las Vegas, NV (US)

(72) Inventor: Hiraku KUDO, Zama-shi (JP)

(21) Appl. No.: 18/538,974

(22) Filed: Dec. 13, 2023

(30) Foreign Application Priority Data
Dec. 16, 2022 (JP) 2022-201404

(51) Int. Cl. G07F 17/32

(52) U.S. Cl. CPC G07F 17/3213; G07F 17/3244; G07F 17/3267

(57) ABSTRACT

The gaming machine includes: an operation unit; a display unit configured to display symbols including credit symbols each associated with a predetermined amount of award; and a control unit connected to the operation unit and the display unit, configured to change and stop the symbols displayed by the display unit, and provide an award based on symbol arrangement formed by the symbols stopped in the display unit, wherein the control unit is configured to: start a bonus event when the symbol arrangement includes at least one credit symbol and a predetermined condition is satisfied; provide a bonus event award based on an amount associated with the at least one credit symbol occurred in the symbol arrangement; accumulate the number of the credit symbols occurred in the bonus event; and increase the bonus event award to be provided in subsequent game based on the number of credit symbols accumulated.

### CROSS-REFERENCE TO RELATED APPLICATIONS

This application claims the benefit of priority from Japanese Patent Application No. 2022-201404, filed on Dec. 16, 2022, the entire contents of which are incorporated herein by reference.

### TECHNICAL FIELD

The present disclosure relates to a gaming machine, a gaming method, and a storage medium.

### BACKGROUND

Australian Patent Publication No. 2018236797 discloses a gaming machine that provides a slot game. The gaming machine spins and stops reels and provides an award when a symbol combination displayed as a game result has a winning combination. The symbol to be displayed includes a credit symbol (prize symbol) associated with a credit value. When the symbol associated with the credit value is included in the winning combination, the gaming machine provides an amount related to the credit value as the award.

### SUMMARY

In the gaming machine described in Australian Patent Publication No. 2018236797, players can immediately understand the credits they can earn, making it easy to follow the progress of game, such as the arrival of a chance to win a high prize. However, for example, since the credit amount attached to the prize symbol continues to show a value within a predetermined range with a predetermined probability, when the game is played for a long time, the stimulation provided to the player by the game becomes monotonous, and the game may fail to keep the player engaged or excited. Therefore, the gaming machine has room for improvement from the viewpoint of providing more attractive games to players.

An object of the present disclosure is to provide a gaming machine, a gaming method, and a storage medium capable of providing a novel game in which players are continuously stimulated in various modes.

A gaming machine according to one aspect of the present disclosure includes: an operation unit configured to receive an operation of a player; a display unit configured to display symbols selected from a plurality of symbols including credit symbols each associated with a predetermined amount of award; and a control unit connected to the operation unit and the display unit, configured to change and stop the symbols displayed by the display unit in response to receiving the operation of the player by the operation unit, and provide an award based on symbol arrangement formed by the symbols stopped in the display unit, wherein the control unit is configured to: start a bonus event when the symbol arrangement includes at least one credit symbol and a predetermined condition is satisfied; provide a bonus event award based on an amount associated with the at least one credit symbol occurred in the symbol arrangement; accumulate the number of the credit symbols occurred in the bonus event; and increase the bonus event award to be provided in subsequent game based on the number of credit symbols accumulated.

According to another aspect of the present disclosure, there is provided a gaming method for providing a game using a gaming machine, the gaming machine including: an operation unit configured to receive an operation of a player; a display unit configured to display symbols selected from a plurality of symbols including credit symbols each associated with a predetermined amount of award; and a control unit connected to the operation unit and the display unit, configured to change and stop the symbols displayed by the display unit in response to receiving the operation of the player by the operation unit, and provide an award based on symbol arrangement formed by the symbols stopped in the display unit, the gaming method executed by the control unit, including: starting a bonus event when the symbol arrangement includes at least one credit symbol and a predetermined condition is satisfied, and providing a bonus event award based on an amount associated with the at least one credit symbol occurred in the symbol arrangement; and accumulating the number of the credit symbols occurred in the bonus event and increasing the bonus event award to be provided in subsequent game based on the number of credit symbols accumulated.

According to still another aspect of the present disclosure, there is provided a non-transitory computer-readable storage medium storing a program for a gaming machine providing a game to a player, the gaming machine including: an operation unit configured to receive an operation of a player; a display unit configured to display symbols selected from a plurality of symbols including credit symbols each associated with a predetermined amount of award; and a control unit connected to the operation unit and the display unit, configured to change and stop the symbols displayed by the display unit in response to receiving the operation of the player by the operation unit, and provide an award based on symbol arrangement formed by the symbols stopped in the display unit, the program configured to cause the control unit to: start a bonus event when the symbol arrangement includes at least one credit symbol and a predetermined condition is satisfied, and provide a bonus event award based on an amount associated with the at least one credit symbol occurred in the symbol arrangement; and accumulate the number of the credit symbols occurred in the bonus event and increase the bonus event award to be provided in subsequent game based on the number of credit symbols accumulated.

According to the present disclosure, there are provided a gaming machine, a gaming method, and a storage medium capable of providing a novel game in which players are continuously stimulated in various modes.

### BRIEF DESCRIPTION OF THE DRAWINGS

FIG. 1 is a perspective view illustrating an example of a gaming machine according to an embodiment.

FIG. 2 is a block diagram showing an example of the configuration of the gaming machine shown in FIG. 1.

FIG. 3 is a schematic diagram of a display area of the gaming machine of FIG. 1.

FIG. 4 is a diagram illustrating an example of a virtual reel set.

FIG. 5 is a diagram illustrating an example of symbols.

FIG. 6 is a diagram illustrating an example of paylines set in the display area of FIG. 3.

FIGS. 7A to 7C are diagrams illustrating an example of a bonus event during a normal game.

FIG. 8 is a diagram illustrating an example of a bonus event during a free game.

FIG. 9 is a diagram illustrating an example of a bonus event during a free game.

FIG. 10 is a diagram illustrating an example of a bonus event during a free game.

FIG. 11 is a diagram illustrating an example of a bonus event during a free game.

FIG. 12 is a diagram illustrating an example of a bonus event during a free game.

FIG. 13 is a directory configuration diagram and a block diagram showing programs and data stored in the memory shown in FIG. 2.

FIG. 14 is a block diagram of a system for a gaming machine.

FIG. 15 is a block diagram of the game application program of FIG. 14.

FIG. 16 is an example of a multiplier value table.

FIG. 17 is a block diagram of the system application program shown in FIG. 14.

FIG. 18 is a flowchart for explaining the operation of the gaming machine.

FIG. 19 is a flowchart for explaining the operation of the gaming machine.

### DETAILED DESCRIPTION

Hereinafter, a gaming machine according to an embodiment will be described with reference to the accompanying drawings. In the drawings, the same or corresponding portions are denoted by the same reference numerals, and redundant description is omitted.

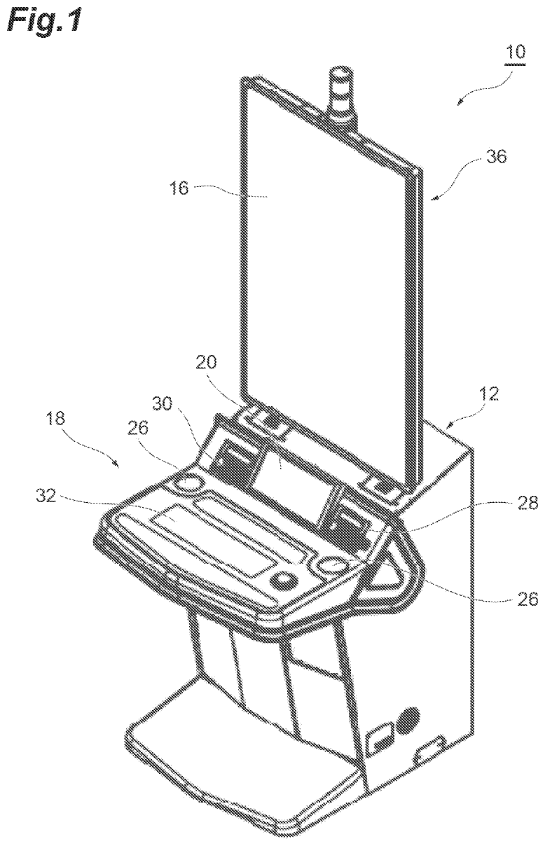

FIG. 1 is a perspective view illustrating an example of a gaming machine according to an embodiment. Here, the gaming machine is a device that receives a wager such as a cash, a medal, or a token from a player, starts a game, and pays a prize, an award, or a payout to the player according to a randomly determined game result. Such a gaming machine is designed and manufactured in accordance with local regulations, and is installed as a device in a licensed facility such as a casino after obtaining authorization by an authorization agency. A gaming machine 10 shown in FIG. 1 may receive a predetermined game value from the player, generate a game result, and provide a payout to the player in response to the game result and a pay table. The gaming machine 10 provides a video slot game as an example. The video slot game includes, for example, a normal game in which a wager is consumed and provided as a compensation therefor, a free game in which a wager is provided without being consumed. The normal game and the free game are provided when a predetermined condition is satisfied. In the normal game and the free game, symbols displayed in the display area constitute a combination of symbols as a game result, and a winning is determined by the combination.

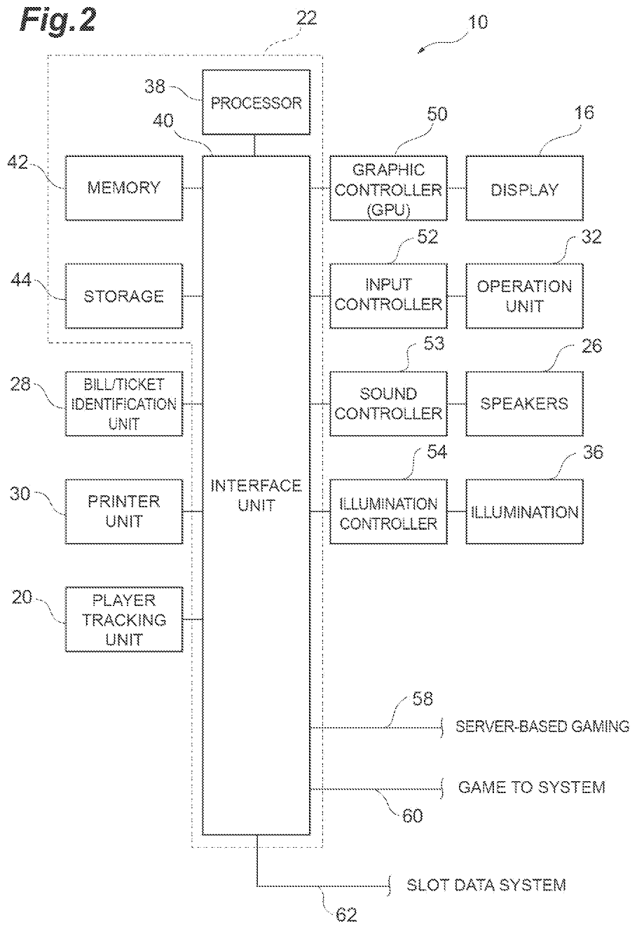

As shown in FIG. 1, the gaming machine 10 includes a display 16 (an example of a display unit) and a cabinet 12. The cabinet 12 also houses a control unit 22 (see FIG. 2) for controlling the components of the gaming machine 10.

The display 16 is a flat panel display device such as a liquid crystal display device or an organic EL display device. The display 16 is controlled via the control unit 22 to provide a game screen to the player. An illumination 36 may be provided around the display 16 to provide decorative lighting.

The cabinet 12 is disposed below the display 16. A control panel 18 is provided on the front surface of the cabinet 12 so as to project forward. The control panel 18 is provided with a player tracking unit 20, speakers 26, a bill/ticket identification unit 28, a printer unit 30, and an operation unit 32.

The player tracking unit 20 includes a card reader for recognizing a player identification card, a display for presenting a data to the player, and a keypad for receiving input by the player. The player tracking unit 20 cooperates with the control unit 22 or an external system to read information recorded on the player identification card inserted into the card reader by the player and display the information and/or information acquired by communicating with the external system on a display. Furthermore, input from the player is received by the keypad, the display is changed according to the input, and communication with an external system is performed as necessary.

The speakers 26 are provided on the left and right of the control panel 18. The speakers 26 are controlled via the control unit 22 to provide sound to the player.

The bill/ticket identification unit 28 may be housed in the cabinet 12 with the insertion opening exposed through which the bill/ticket is inserted. An identification part for identifying bill/ticket by various sensors is provided inside the insertion port. A bill/ticket storage part is provided on the output side of the identification part. The bill/ticket identification unit 28 accepts bill/tickets (including vouchers and coupons) that are the gaming value, identifies them as the gaming value, and notifies the control unit 22.

The printer unit 30 may be accommodated in the cabinet 12 in a state where a ticket output port through which the ticket is output is exposed. A printing part for printing predetermined information on a printing paper is provided inside the ticket output port, and a housing part for housing the printing paper is provided on the paper inlet side of the printing part. The printer unit 30, under control of the control unit 22, prints information on paper and outputs a ticket from the gaming machine 10 according to credit payout processing. The output ticket may be inserted into the bill/ticket identification unit 28 of another gaming machine to use the payout credit for game play, or may be exchange for cash by a kiosk terminal inside of the casino or casino cage.

The operation unit 32 receives an operation of the player. The operation unit 32 includes a group of buttons for receiving various instructions from the player on the gaming machine 10. The operation unit 32, for example, may include a group of a spin button and setting buttons. The spin button receives an instruction to start an instance of a game (start rotation of reel). The group of setting buttons includes a group of line-designation buttons, a group of bet buttons, a cash-out button and the like. The group of bet buttons receives an instruction operation related to a credit amount of a bet (bet amount) from a player. The cash-out button receives an instruction operation for instructing payout of credit accumulated in the gaming machine 10.

FIG. 2 is a block diagram illustrating an example of the configuration of a gaming machine. The gaming machine 10 includes the control unit 22. The control unit 22 includes a central processing unit (CPU) 38 including a processor constituting the control unit 22, an interface unit 40, a memory 42, a storage 44, and the like. The control unit 22 may be housed inside the cabinet 12 as a control board. The control unit 22 is configured to be able to communicate with each unit via the interface unit 40, and controls the operation of each unit by executing a program recorded in the memory 42 and/or the storage 44 of CPU 38 to provide a game to the player.

The interface unit 40 includes a chipset that provides communication functions of CPU 38, such as a memory bus connected to the CPU 38, various expansion buses, a serial interface, a universal serial bus (USB) interface, an Ethernet interface (registered trademark) and the like.

The memory 42 may include a random-access memory (RAM) that is a volatile storage medium, a read only memory (ROM) that is a nonvolatile storage medium, and an electrically erasable programmable read-only memory (EEPROM) that is a rewritable nonvolatile storage medium. The storage 44 provides the control unit 22 with a function as an external storage device, and can use a reading device such as a memory card and a magneto-optical disk which are removable storage media, and can also use a hard disk.

The bill/ticket identification unit 28, the printer unit 30, a player tracking unit 20, a graphic controller (GPU: Graphics Processing Unit) 50, an input controller 52, a sound controller 53, and an illumination controller 54 are connected to the interface unit 40. The graphic controller 50, the input controller 52, the sound controller 53, and the illumination controller 54 may be housed inside cabinet 12 as control boards.

The control unit 22 is connected to the display 16 via the graphic controller 50. The control unit 22 is connected to the operation unit 32 via the input controller 52. The control unit 22 is connected to the illumination 36 via the illumination controller 54.

The control unit 22 controls each unit by executing programs stored in the memory 42 and the storage 44, and provides the game to the player. Here, for example, the program and data of the operating system and subsystem providing basic functions of the control unit 22 may be stored in the EEPROM of the memory 42, and the program and data of the application providing the game may be stored in the storage 44. According to such a configuration, the game can be easily changed or updated by exchanging the storage 44. Furthermore, the control unit 22 may have a multiprocessor configuration including a plurality of CPUs.

Hereinafter, each block connected to the control unit 22 will be described. The bill/ticket identification unit 28 accepts the bill/ticket at the insertion port and notifies the control unit 22 of identification information corresponding to the assortment of bills or payout processing of credit. The control unit 22 increases the credit amount usable in the game according to the notified contents. The printer unit 30 prints information corresponding to payout processing of credit from the gaming machine 10 on a ticket and output under the control of the control unit 22 which receives the operation of a cash-out button included in the operation unit 32.

The player tracking unit 20 cooperates with the control unit 22 to transmit and receive player information and the like to and from the casino management system. The graphic controller 50 controls the display 16 under control of the control unit 22 to display a display image including various graphics data. The sound controller 53 drives the speakers 26 under the control of the control unit 22 to provide various sounds such as announcements, sound effects, BGM and the like. The illumination controller 54 performs lighting control of the illumination 36 under the control of the control unit 22.

The interface unit 40 includes various communication interfaces for communicating with the exterior of the gaming machine 10. The interface unit 40 may communicate with external networks by Ethernet 58, 60 and a serial interface 62, as examples. FIG. 2 shows an example of communication with other the gaming machine 10, a known server-side gaming network (Server-Based gaming), a G2S network (Game to system), and a slot information system (Slot Data System).

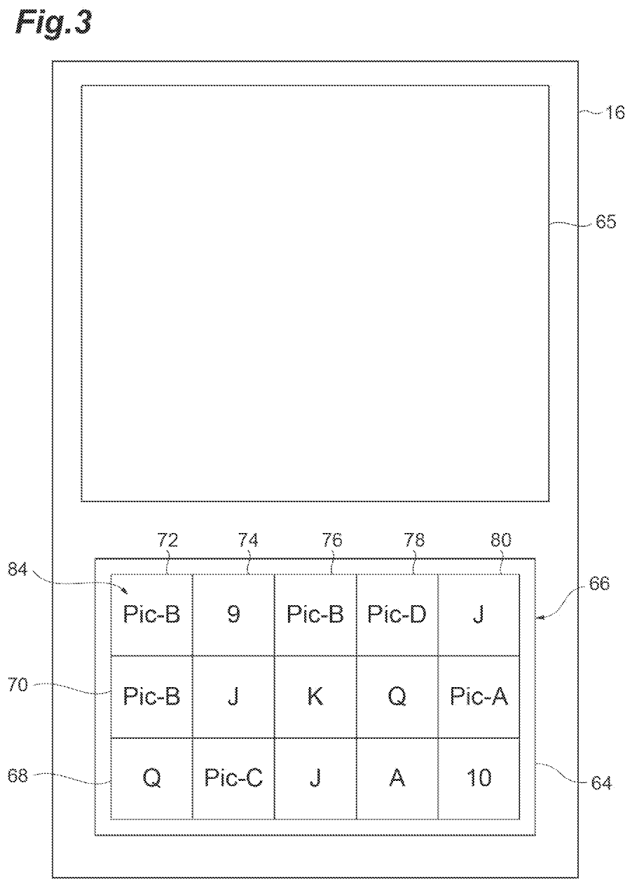

FIG. 3 is a diagrammatic illustration of a display area of the gaming machine in FIG. 1. As shown in FIG. 3, a game screen having a symbol display area 64 for displaying a slot game and an information display area 65 displaying information related to game content is displayed on the display 16 by the control unit 22 executing a predetermined program. The symbol display area 64 is displayed in a lower region of the game screen. The information display area 65 is provided in parallel with the symbol display area 64, and is displayed in an upper region of the game screen as an example.

The symbol display area 64 includes a grid 68 capable of displaying symbols. By using such a display area, the gaming machine 10 operates as a slot machine that performs a winning determination according to a combination of symbols displayed on the grid 68 in the symbol display area 64 and provides a payout.

The display 16 displays a plurality of symbols in the grid 68. The grid 68 includes a plurality of rows and columns. The grid 68 is constituted by a plurality of a cell 70 which are stop positions of symbols. FIG. 3 illustrates a game screen including a plurality of cells arranged in a 5×3 grid pattern. The number of columns and the number of rows of the grid are not particularly limited, and may be another configuration such as 5×4, 3-4-4-4-3, 6×3, 6×4, or 3-3-3-5-5, or may be a configuration that increases or decreases according to the game development and/or the bet amount. One symbol is stopped and displayed on each of a plurality of the cell 70 in the symbol display area 64.

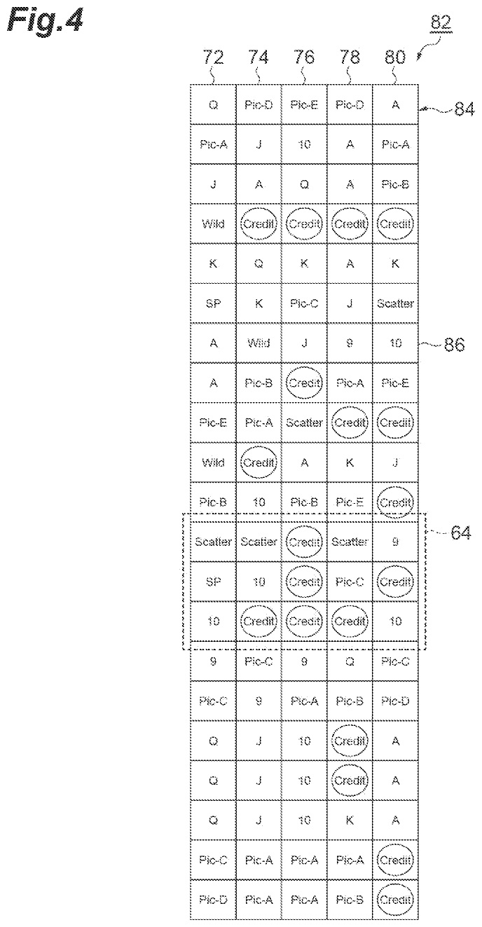

The symbol arranged in each of the plurality of cells 70 is determined by using, for example, a virtual reel strip for partially displaying a virtual reel 66. FIG. 4 is figure showing a virtual reel set. The virtual reel set includes a plurality of virtual reel strips, and the virtual reel strip includes symbol arrangements indicating the order of symbols displayed in the display area. As shown in FIG. 4, on each the cells 70 of the grid 68, symbols are displayed based on symbol arrangements of the virtual reel 66 including a virtual reel strips 72, 74, 76, 78, and 80 which form a virtual reel set 82. That is, the cells 70 of the grid 68 correspond to the virtual reel strips 72 to 80 by column, and the symbols arranged in predetermined parts of each virtual reel strips 72 to 80 are displayed. Furthermore, by moving (scrolling or spinning) each symbol by column based on the symbol arrangement of the virtual reel strips 72 to 80, the symbols displayed in the cells 70 of the grid 68 change, and by stopping the movement (scrolling or spinning) by columns, the symbols are stopped. Here, the virtual reel strips 72 to 80 are data where the control unit 22 uses a program having the memory 42 or the storage 44, and data showing the symbol arrangement (i.e., the order of symbols on each reel) regulated by each cell column. The virtual reel set 82 is a general term for such virtual reel strips 72 to 80.

The virtual reel strips 72 to 80 illustrated in FIG. 4 are constituted by symbols in each symbol position 86, and these symbols are arranged in an order defined for each reel. The number of symbols forming the virtual reel strips 72 to 80 is not limited thereto, and may be a desired number. The number of symbols forming the virtual reel strips 72 to 80 may be the same or may be different from each other.

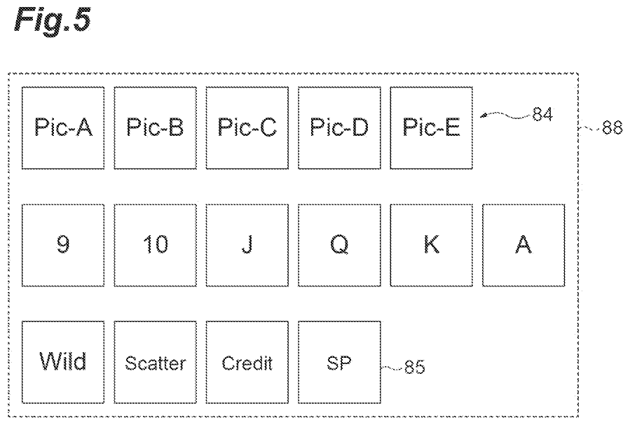

FIG. 5 is a detail of the symbols 84 shown in FIG. 4. Each of the virtual reel strips 72 to 80 includes symbols selected from a symbol set 88 of various the symbol 84 shown in FIG. 5. The symbol set 88 includes card symbols (“9”, “10”, “J”, “Q”, “K”, and “A”) imitating playing cards as regular symbols, and picture symbols (“Pic-A”, “Pic-B”, “Pic-C”, “Pic-D”, and “Pic-E”) indicating a pattern.

The symbol set 88 includes a wild symbol (“Wild”) that is substituted as another symbol when a winning combination is determined, a scatter symbol (“Scatter”) that triggers a free game in response to the appearance of a predetermined number of symbols when a winning combination is determined, a credit symbol (“Credit”) associated with a predetermined amount of award, and a special symbol 85 (“SP”). “Triggering a free game” means “Create opportunities to win a free game”. The symbol set 88 may include a plurality of wild symbols, scatter symbols, credit symbols, and/or special symbols 85.

Since the credit symbol urges the player to directly understand the credit that can be acquired and to directly understand the chance by the appearance of the credit symbol with which the high credit is associated, the player's interest can be maintained or improved. The credit symbol can be, for example, a predetermined picture symbol such as coin on which the associated credit amount is displayed. Furthermore, the credit amount may not be displayed on the credit symbol while the symbol is changed, and the credit amount may be displayed after the symbol is stopped, or the credit amount may be displayed when winning occurs after the symbol is stopped. Instead of the credit amount, a jackpot tire may be associated with the credit symbol. The jackpot tire is a level corresponding to the amount of the winning award, such as MINI, MAJOR, MAXI, or MEGA.

The occurrence of the special symbol 85 is a trigger condition of a bonus event. The bonus event means that a rule different from a rule for providing award according to a combination of symbols on payline is applied to game. The bonus event according to the present embodiment uses a credit symbol, and a rule that an amount associated with the displayed credit symbol can be acquired is applied. That is, during the bonus event occurrence, regardless of payline, the amount associated with the displayed credit symbol is provided to the player as award. An award provided to the player in a game in which a bonus event has occurred is referred to as a bonus event award. The event trigger condition includes a credit symbol being displayed in symbol arrangement. The event trigger condition may include at least one special symbol 85 and at least one credit symbol being displayed in symbol arrangement. For example, the event trigger condition may be satisfied when the special symbol 85 is displayed in the first reel of the symbol display area 64 by the virtual reel strip 72 and the credit symbol is displayed in at least one reel from second reel to fifth reel. Details of the bonus event will be described later.

A plurality of virtual reel sets may be prepared according to the game content. For example, the virtual reel set used in the normal game may be different from the virtual reel set used in the free game. The virtual reel set in the free game may include more picture symbols, wild symbols, scatter symbols, or credit symbols than the virtual reel set in the normal game. It is possible to increase the winning probability or the trigger probability during the free game, and it is possible to provide the player with a valuable free game. The virtual reel set in the free game may include more the special symbols 85 than the virtual reel set in the normal game. In this way, the occurrence probability of bonus event winning in the free game can be increased. Alternatively, the virtual reel set to be used may be switched based on a random number.

Further, although FIG. 4 shows an example where any symbol is fixedly arranged in each symbol position 86 of the virtual reel strips 72 to 80 forming the virtual reel 66, the symbols arranged in symbol positions 86 may be dynamically determined. For example, symbols arranged in a part of the symbol positions 86 may be randomly determined by a random number, and in this case, a predetermined type of the same symbols randomly determined may be arranged in a plurality of the symbol positions 86. Furthermore, a plurality of groups of the symbol positions 86 in which the same symbols are arranged may be provided, and symbols randomly determined for each group may be arranged, or symbols may be dynamically arranged for all the symbol positions 86.

The control unit 22 starts the game and randomly determines the stopping position of each of the virtual reel strips 72 to 80. The virtual reel strips 72 to 80 displayed on the display 16 moves (scrolls or spins) from the current position and stops based on the stopping position to represent the game result. Therefore, in the display 16 or the grid 68, the symbols included in the virtual reel strips 72 to 80 fluctuate in accordance with continuous movement (scrolling or spinning) of the virtual reel strips 72 to 80 in the vertical direction of the symbol display area 64, and are displayed such that one symbol is stopped in one cell 70 according to the order of the symbols defined in the virtual reel strips 72 to 80.

The control unit 22 may be configured to change a plurality of symbols displayed on the display 16 by the above-described method in accordance with the operation of the player received by the operation unit 32, stop the symbols in a predetermined order, and provide a payout in accordance with the symbols stopped in the symbol display area 64.

Paylines are set for the symbol display area 64. Each of the paylines consists of a part of the cells, and a plurality of paylines is set in the symbol display area 64. For example, payline is set so as to cross the symbol display area 64 from cell in the leftmost column to the rightmost column. An example of the payline can be composed of any cell in the leftmost column, any cell in the second column from the left, any cell in the third column from the left, any cell in the fourth column from the left, and any cell in the fifth column from the left (rightmost column). In the 5×3 matrix, 243 (3 to the 5th power) types of paylines can be set, however, 40 types or 50 types of paylines may be set. With respect to the game result which is a combination of symbols, the control unit 22 determines winning when the identical or similar (same type of) symbols are aligned on a payline in excess of a predetermined number, and provides a payout to the player in accordance with the type and number of symbols. Further, the payline may be set so as to cross the symbol display area 64 from the cell of the upper end row toward the cell of the lower end row, or the payline may be configured by cells arranged in a predetermined shape such as a triangle or a rectangle, or a character/symbol shape.

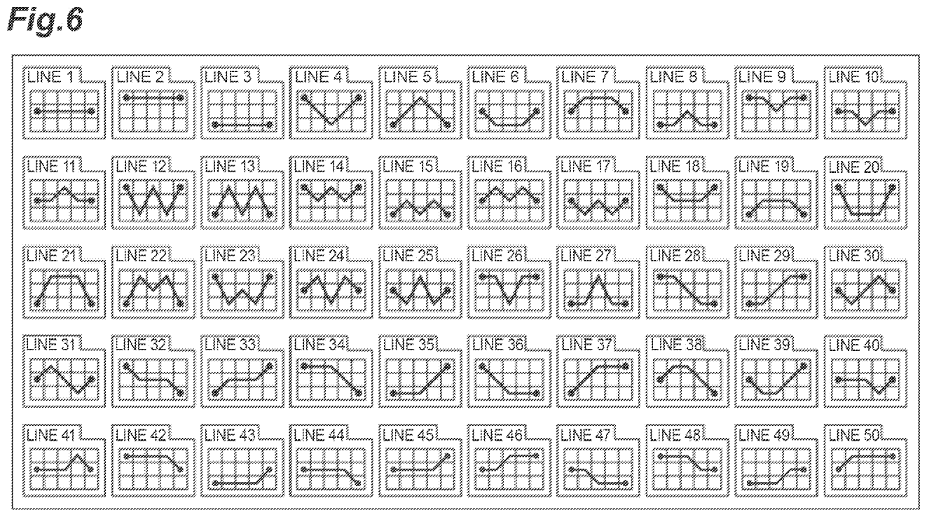

FIG. 6 is a diagram showing an example of paylines set in the symbol display area 64 of FIG. 3. As shown in FIG. 6, in the gaming machine 10, a predetermined number of paylines (50 patterns of lines) are set in advance in cells of three rows and five columns in the symbol display area 64. The system for determining winning may determine winning when a predetermined number of same symbols are arranged from the cell of the leftmost column on the payline, may determine winning when a predetermined number of same symbols are arranged from the cell of the rightmost column on the payline, or may determine winning when a predetermined number of same symbols are arranged in consecutive columns on a predetermined payline regardless of whether the symbols are arranged from the left end or the right end. In addition, more than a predetermined number of scatter symbols form a winning combination or trigger condition regardless of paylines.

The gaming machine 10 of the present embodiment provides a normal game (also referred to as a main game, a prime game, or a base game) provided when a predetermined condition is not satisfied and the free game provided when a predetermined condition is satisfied. The free game is provided when a predetermined trigger condition is satisfied, and can be played without consuming the game value.

In the normal game and the free game, symbols displayed in the symbol display area 64 among symbol arrangements configuring game results are subject to winning determination. That is, the control unit 22 that has started the game randomly determines a stopping position for each of the virtual reel strips 72 to 80 shown in FIG. 4, and expresses an animation in which the virtual reel strips 72 to 80 moves from the current position and stops at the stopping position using the display 16. Accordingly, in the symbol display area 64, the symbols arranged on the virtual reel strips 72 to 80 continuously move (scroll) in the vertical direction, and stop so that one symbol is displayed on one the cell 70 while maintaining continuity.

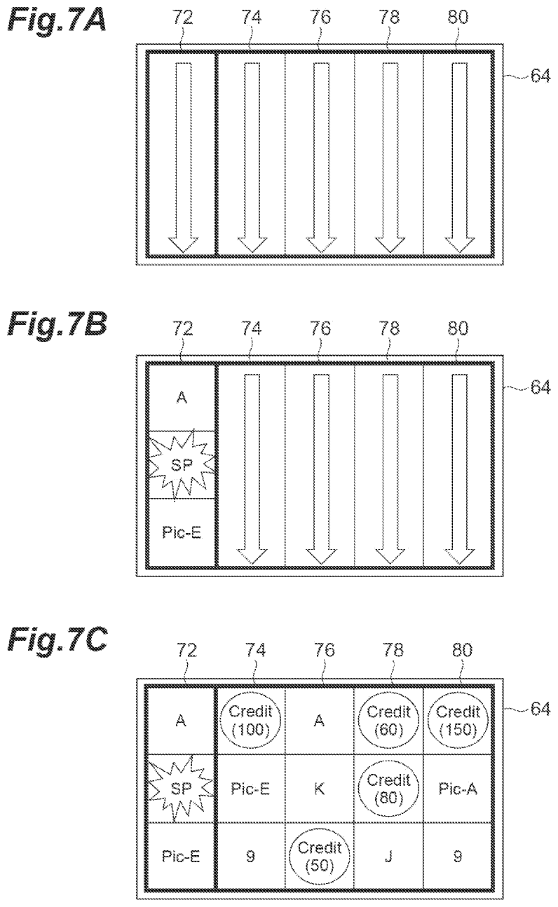

However, in the present embodiment, a bonus event described below may occur in the normal game and the free game. As a result, a bonus event award of an amount associated with the credit symbol is provided. Hereinafter, bonus events occurring in the normal game and the free game will be described with reference to FIGS. 7A to 12.

FIGS. 7A to 7C are diagrams illustrating an example of a bonus event during a normal game. As illustrated in FIG. 7A, when the game is started, the control unit 22 continuously moves (scrolls) the symbols arranged in the virtual reel strips 72 to 80 in the symbol display area 64 in the vertical direction.

Next, as shown in FIG. 7B, when the first reel is stopped and the second reel to the fifth reel are spinning, the special symbol 85 indicated by “SP” is stopped in the first reel. When the credit symbol is stopped in at least one reel from second reel to fifth reel, the trigger condition of the bonus event is satisfied and the bonus event starts. In a bonus event in a normal game, an amount associated with the credit symbol displayed on the symbol display area 64 is provided to the player as a bonus event award. In the example illustrated in FIG. 7C, a credit symbol associated with “100” is displayed in second reel. Similarly, a credit symbol associated with “50” is displayed in third reel, a credit symbol associated with “60” and a credit symbol associated with “80” are displayed in fourth reel, and a credit symbol associated with “150” is displayed in fifth reel. Therefore, total amount “440” is provided as bonus event award. The order of stopping the reels is arbitrary, and the first reel may be stopped last.

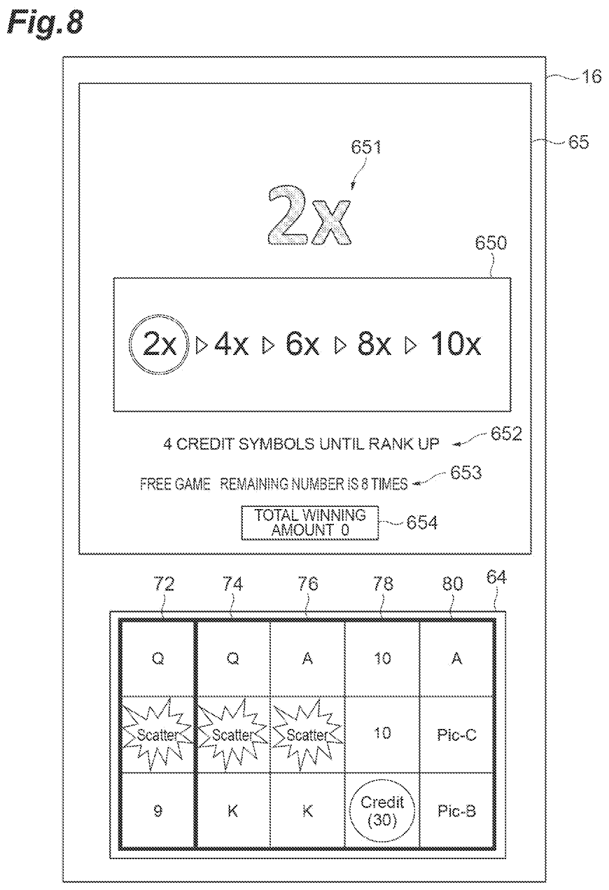

FIGS. 8 to 12 are diagrams illustrating examples of bonus events during a free game. As shown in these figures, at the time of free game, in response to the occurrence of a bonus event in which a credit symbol is occurred in symbol arrangement, the control unit 22 provides a bonus event award of an amount associated with the displayed credit symbol, accumulates (stores up) the number of credit symbols displayed at the time of occurrence of the bonus event, and increases a bonus event award to be provided later based on the accumulated number. In the game according to the embodiment, it is assumed that eight free games are triggered by three scatter symbols (“Scatter”) appearing in the symbol display area 64. Note that the trigger condition of the free game and the number of free games to be assigned are not limited thereto, and can be set as appropriate. As shown in FIG. 8, when the free game is triggered with respect to the result of the normal game, information about the free game is displayed on the information display region 65 before the start of the free game. The information about the free game includes a multiplier value display 651 indicating a multiplier value given to a bonus event award in the next game. The multiplier value display 651 notifies a multiplier value (here, twice as an example) given to the bonus event award in the next game (here, the first time of the free game).

Further, the multiplier value given to the bonus event award in the next game is updated when the rank-up condition is satisfied. The information about the free game includes a multiplier value list 650 indicating multiplier value that may be given to the bonus event award during the free game and a condition display 652 indicating a rank-up condition. As shown in FIG. 8, the multiplier value list 650 displays “2×”, “4×”, “6×”, “8×”, and “10×”, and it is notified that 2 times, 4 times, 6 times, 8 times, or 10 times can be given as the multiplier value of the bonus event award. The multiplier value that can be given to the bonus event award can be arbitrarily set. In the multiplier value list 650, the current multiplier value may be highlighted. In the example shown in FIG. 8, the display of “2×” is surrounded by a circle to highlight the multiplier value at the present time. The highlighting may be realized by changing the size, color, brightness, or the like of the characters.

The rank-up condition indicated by the condition display 652 is conditioned on the number of occurrences of credit symbols. For example, the number of occurrences of credit symbols is accumulated during a predetermined number of continuous free games. For example, when the free game can be played eight times, the cumulative value is the total number of credit symbols appearing in the eight free games. When the free game is further acquired during the free game, the number of credit symbols appearing in the acquired free game is also accumulated.

When the cumulative number of credit symbols appearing in the continuous free game satisfies the rank-up condition, the value given to the bonus event award is updated. The rank-up condition of the game according to the present embodiment is rank-up whenever a predetermined number of credit symbols are accumulated. In the rank-up condition, the rank is increased by one every time four credit symbols appear. That is, when the cumulative number is 0 to 3, it is doubled; when the cumulative number is 4 to 7, it is quadrupled; when the cumulative number is 8 to 11, it is 6-fold; when the cumulative number is 12 to 15, it is 8-fold; and when the cumulative number is 16 or more, it is 10-fold. The condition display 652 indicates a rank-up condition of “four credit symbols until rank up”. Note that the number of credit symbols, which is a condition for rank up, can be arbitrarily set.

The information about the free game may include a number display 653 indicating the remaining number of the free game and an amount display 654 indicating a total winning amount obtained in a continuous free game. As indicated by the number display 653 shown in FIG. 8, the remaining number of the free game is 8 times.

By displaying the information on the free game, the player can recognize that the bonus event award is increased by the multiplier value and that the multiplier value is increased. Therefore, it is possible to easily recognize that the chance of high payout has come. Further, since the number of credit symbols becomes a condition for rank increase of multiplier value, the appearance of the credit symbol becomes a trigger for acquisition of the credit amount and also a trigger for rank increase of multiplier value. By increasing the functions performed by the credit symbol in this manner, it is possible to provide a game in which the player is stimulated in various modes, and it is possible to provide a game in which stimuli of different strengths are continuously given to the player since the multiplier value is sequentially ranked up.

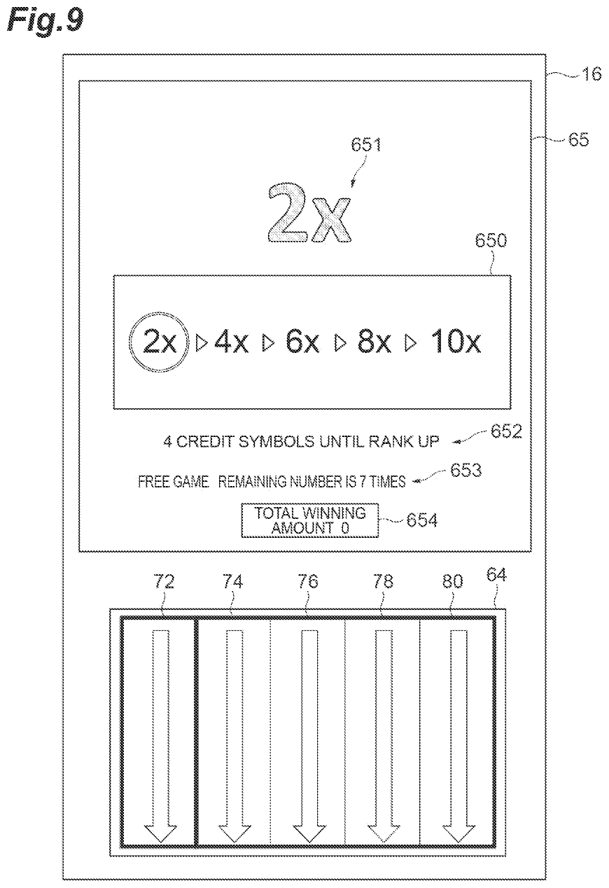

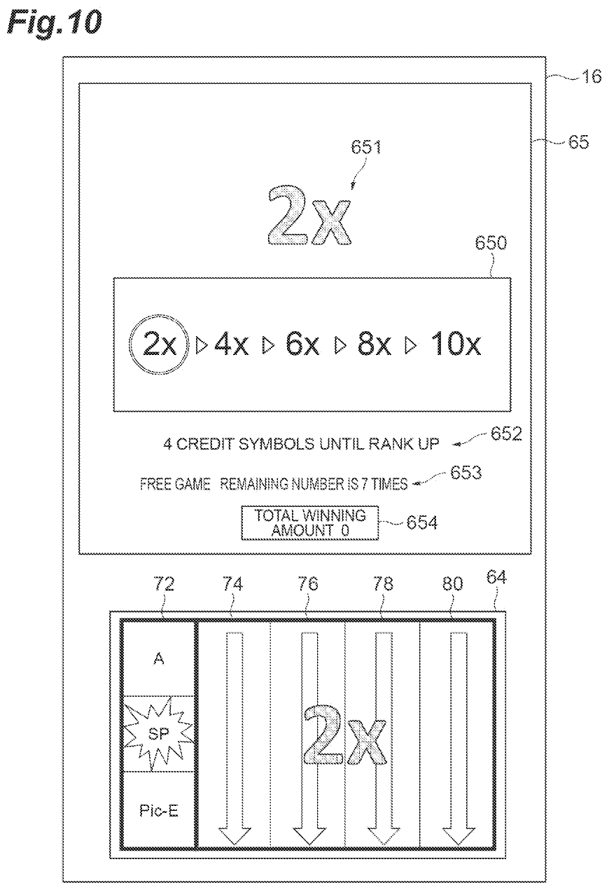

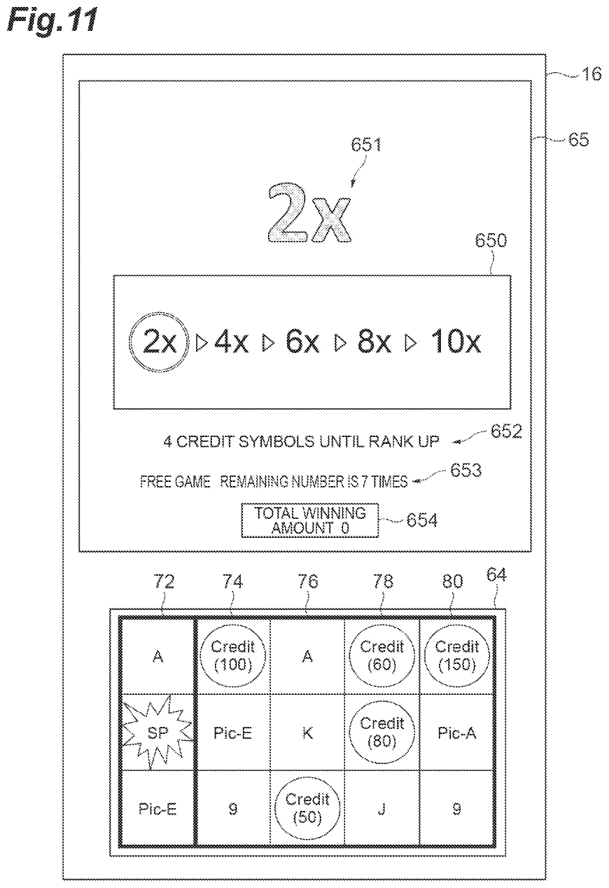

As shown in FIG. 9, when the free game is started, the remaining number of the free game is subtracted once and displayed by the number display 653. In this case, the number of times is seven. The symbols arranged on the virtual reel strips 72 to 80 continuously move (scroll) in the vertical direction. Then, as shown in FIG. 10, it is assumed that the first reel stops and the special symbol 85 indicated by “SP” is displayed in the first reel. At this time, in the symbol display area 64, when credit symbols are displayed on the second to fifth reels, which are the remaining reels, it is notified that the credit symbol becomes double. As shown in FIG. 11, when credit symbols are displayed from second reel to fifth reel, an bonus event occurs. In the example illustrated in FIG. 11, a credit symbol associated with “100” is displayed in second reel. Similarly, a credit symbol associated with “50” is displayed in third reel, a credit symbol associated with “60” and a credit symbol associated with “80” are displayed in fourth reel, and a credit symbol associated with “150” is displayed in fifth reel. The order of stopping the reels is arbitrary, and the first reel may be stopped last.

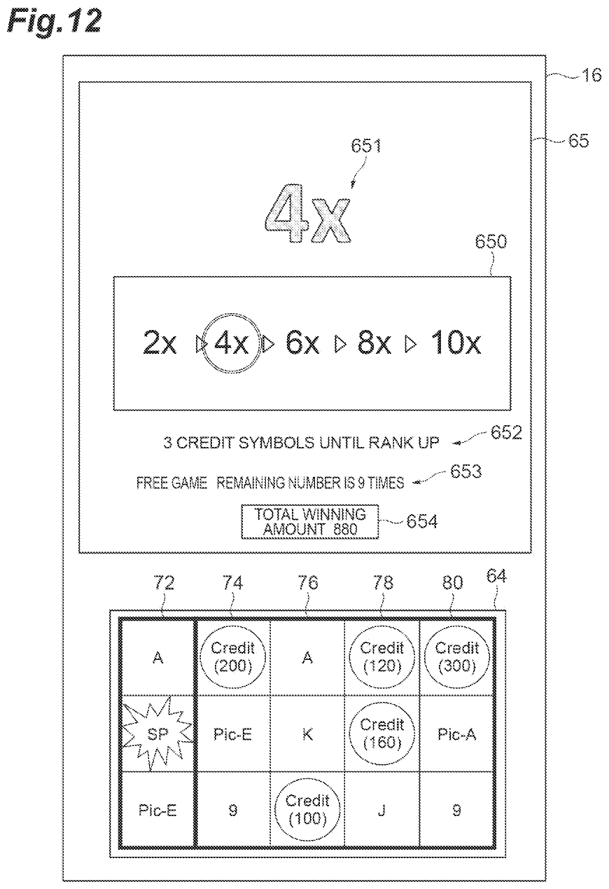

The value associated with the credit symbol displayed in FIG. 11 is doubled and redisplayed as shown in FIG. 12. In second reel, the credit symbol associated with “100” is associated with “200”. Similarly, the credit symbol associated with “50” is associated with “100” in third reel; the credit symbol associated with “60” is associated with “120” and the credit symbol associated with “80” is associated with “160” in fourth reel; and the credit symbol associated with “150” is associated with “300” in fifth reel. In this way, by presenting the player before and after the application of the multiplier value, it is possible to make the player easily recognize the effect of the bonus event. Note that the redisplay may be performed for each reel or may be performed collectively for all the reels. As described above, in the bonus event in the free game, the multiplier value is applied to the value associated with the credit symbol, and the bonus event award of the total amount “440” before the application becomes the total amount “880”.

Further, as shown in FIG. 12, there are five credit symbols displayed on the symbol display area 64. In other words, the appearance of four credit symbols that are rank-up conditions is satisfied. Therefore, the multiplier value given to the bonus event award in the next game is updated from two times to four times, and the multiplier value display 651 is updated from “2×” to “4×”. Also, in the multiplier value list 650, “4×” is highlighted. In the condition display 652 as well, the rank-up condition is updated to “three credit symbols until rank up”. Further, the remaining number of the free game as the rank-up bonus is increased by a predetermined number of times (here, two times as an example). The remaining number of the free game displayed by the number display 653 is updated from “7 times” to “9 times”. The number of free games awarded as a rank-up bonus is arbitrary. In addition, by providing a free game at the time of rank-up, it is possible to avoid a situation in which the next game cannot be played despite the rank-up. The amount display 654 indicating the total winning amount acquired in the continuous free game is “880”.

As described above, the bonus event in the free game is different from the bonus event in the normal game in that the multiplier value is applied to the value associated with the displayed credit symbol and that the multiplier value given to the bonus event award is increased in accordance with the cumulative number of the credit symbol in which the applied multiplier value appears. Therefore, the credit symbol in the present embodiment not only urges the player to directly understand the credit that can be obtained, but also constitutes a game that stimulates the player in various modes as a trigger for increasing the multiplier value given to the bonus event award in the next game according to the cumulative number of occurrences, and as a trigger for increasing the number of free games. Although it is not essential to increase the number of free games, since the cumulative number of credit symbols that have appeared can be further increased to rank up the multiplier value, it is effective in providing a game rich in stimulus to the player.

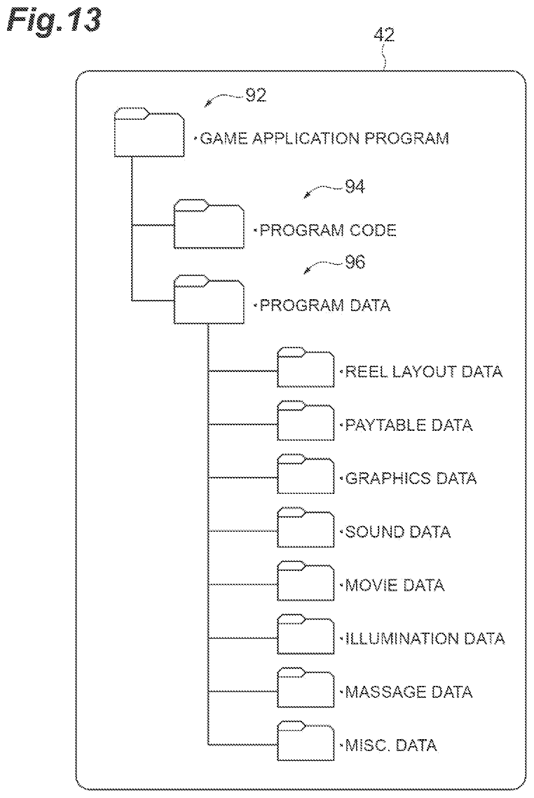

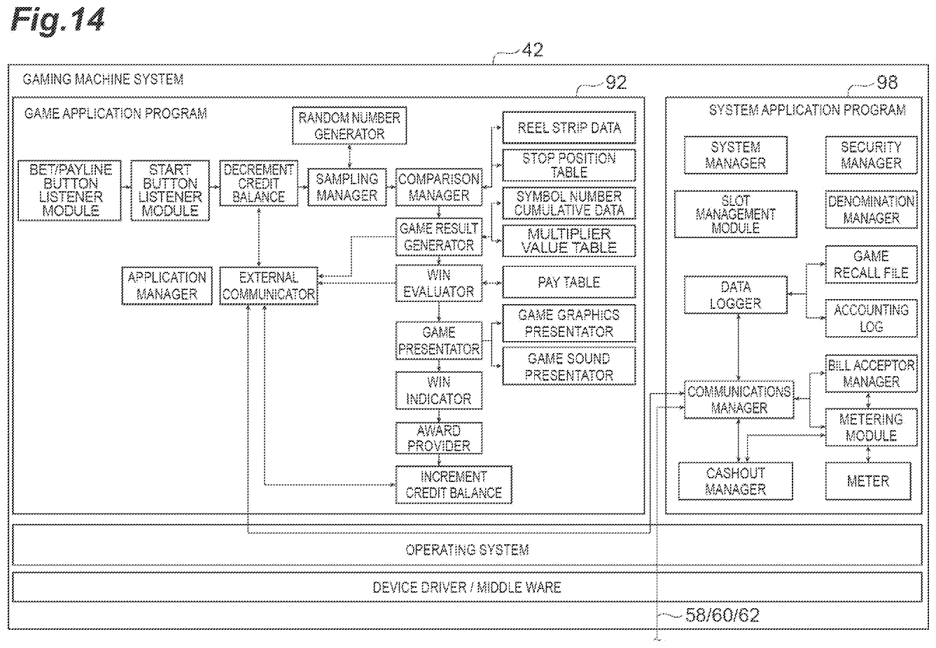

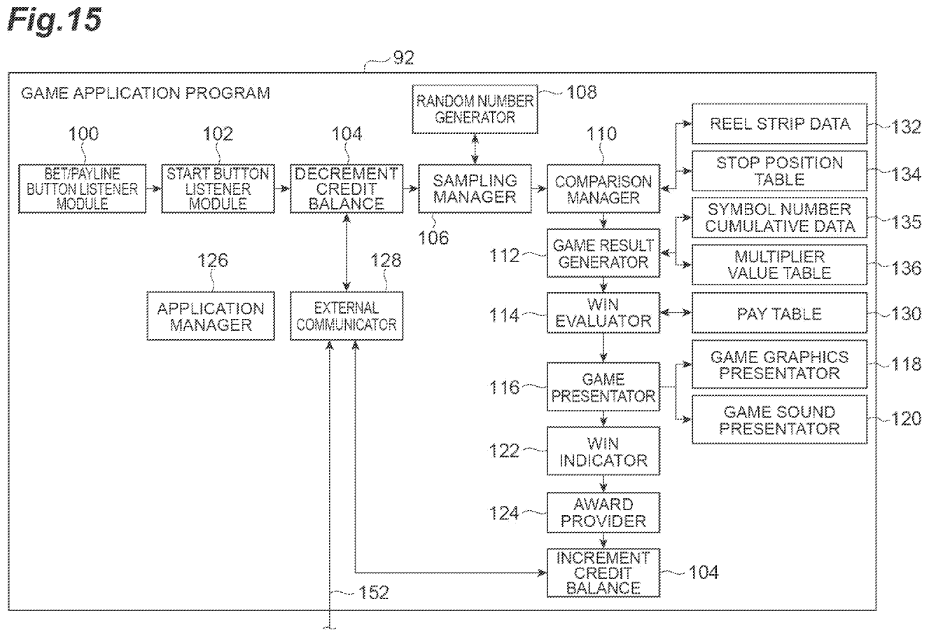

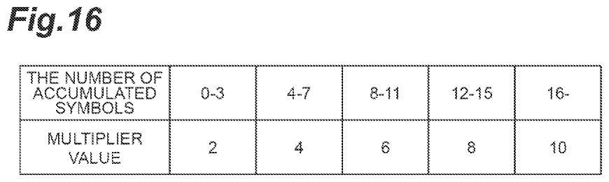

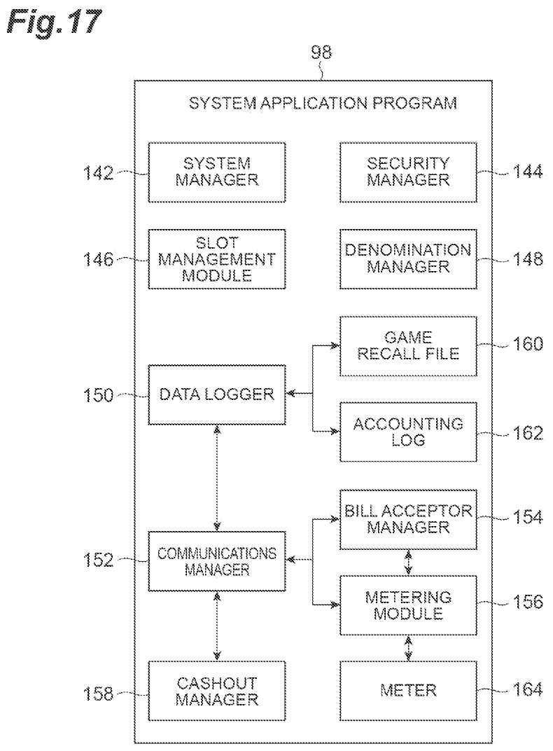

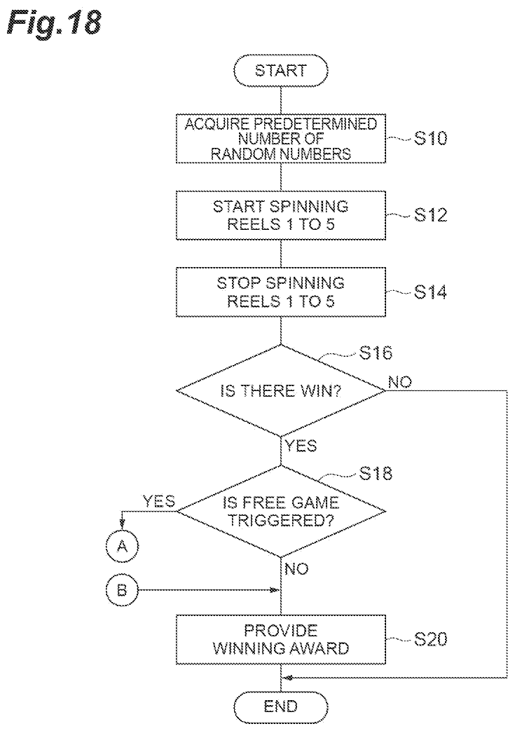

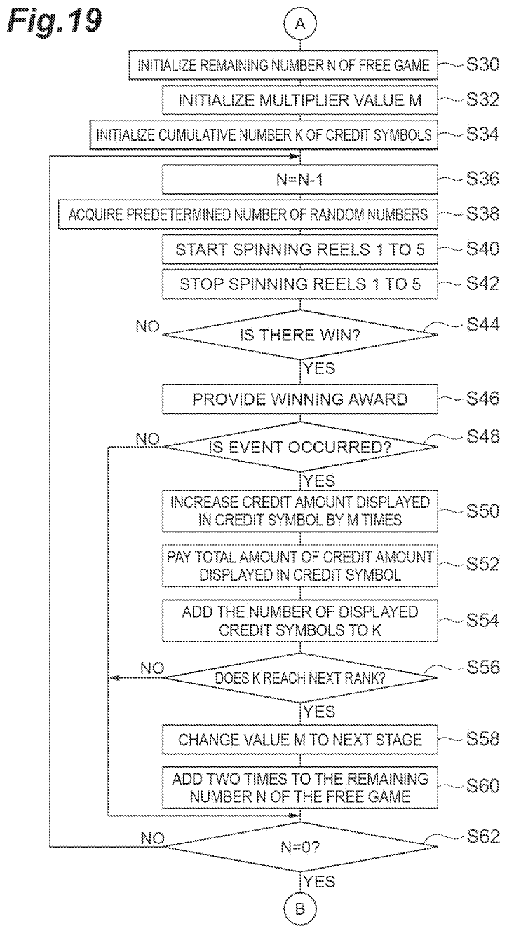

FIGS. 13 and 14 are a directory configuration diagram and a block diagram showing a program and data stored in the memory of FIG. 2. FIG. 15 is a block diagram of the game application program of FIG. 14. FIG. 16 is an example of a multiplier value table. FIG. 17 is a block diagram of the system application program shown in FIG. 14. In the embodiments shown in FIGS. 13 to 17, the memory 42 stores a game application program 92 including computer-executable instructions, and processing of the game is performed by executing these computer-executable instructions in CPU 38, and the game screen is displayed on the display 16 in the gaming machine 10. Also, in one embodiment, the game application program 92 includes a program code 94 and a program object data 96 that includes computer-executable instructions for implementing a game using the algorithms shown in FIGS. 18 and 19.

In an exemplary embodiment, the memory 42 stores the game application program 92 and a system application program 98 including computer-executable instructions that are executed in the CPU 38 to process the game and display a game screen on the display 16 of the gaming machine 10. The game application program 92 provides a game specific/front-end function by executing on the CPU, and the system application program 98 provides a generic/back-end function. In the illustrated embodiment, the game application program 92 and the system application program 98 are implemented on the same operating system. However, it should be noted that these programs may be implemented on different operating system and/or by different processors.

In one embodiment, the game application program 92 includes a plurality of software modules including a bet/payline button listener module 100, a start button listener module 102, a credit balance manager module 104, a sampling manager 106, random number generator (RNG) 108, a comparison manager 110, a game result generator 112, a win evaluator 114, a game presentator 116, a game graphics presentator 118, a game sound presentator 120, a win indicator 122, an award provider 124, an application manager 126, and an external communicator 128. The game application program 92 may also include a pay table 130, a reel strip data 132, and a stop position table 134.

The bet/payline button listener module 100 is a software module for receiving a signal from a bet button 34 or a line-designation button 33 of the operation unit 32, the signal is generated by buttons when the player operates the buttons to select bet amount or the number of paylines to activate. In response to receiving the signal, the bet/payline button listener module 100 communicates the occurrence of the signal to the application manager 126 for changing the configuration of the activated payline or betting the game.

The start button listener module 102 is a software module for receiving a signal from a start button, which is generated when the player operates the button to start a game. In response to receiving the signal, the start button listener module 102 communicates the occurrence of the signal to the application manager 126 to initiate the game.

In response to receiving a signal from the start button listener module 102, the application manager 126 requests the sampling manager 106 to obtain the required number of random numbers from the random number generator 108.

The random number generator 108 is a software module for generating random numbers based on predetermined algorithm of computational random generation method. The random number generator 108 may be a pseudorandom generator. The random number generator 108 returns the random numbers in response to a request from the sampling manager 106. The random number generator 108 may be implemented in part or in whole as integrated circuits or wired logic.

The comparison manager 110 compares the current state of the game and/or each random number with the reel strip data 132 and the stop position table 134, and specifies the stopping position of the corresponding reel strip based on each random number.

The reel strip data 132 has virtual reel strips for normal games, free games, and special games. The comparison manager 110 described above queries the application manager 126 to identify the current state of the game and selects virtual reel strips.

The stop position table 134 includes a range of random numbers associated with each stopping position of the virtual reel strip. The comparison manager 110 determines the stopping position of each reel based on the corresponding random number and the stop position table 134.

The game result generator 112 generates a game result based on the selected reel layout, the stopping position of each reel, the stopping position of the inner symbol, and the attribute to be added. The number of credit symbols included in the game result is accumulated in a symbol number cumulative data 135. The game result generator 112 determines a multiplier value to be applied to the bonus event award based on the value accumulated in the symbol number cumulative data 135 and a multiplier value table 136. As shown in FIG. 16, the multiplier value table 136 is a table that associates the number of accumulated symbols with multiplier value. In one embodiment, the game result generator 112 may apply a modification on the game result when a predetermined condition is satisfied.

The win evaluator 114 evaluates the game result with reference to the pay table 130. To be specific, the winning evaluation is performed based on whether symbols defined as a winning combination in the pay table 130 stops on the payline in the symbol display area 64.

The game presentator 116 utilizes the game graphics presentator 118 and the game sound presentator 120 to provide a game presentation process consisting of video animation and sound to eventually form a predetermined game result.

The game sound presentator 120 provides a sound presentation process by using the sound controller 53 and speakers 26. The win indicator 122 indicates a winning combination and a payment condition of prize symbols formed in the game result. The award provider 124 provides award credit to the win meter based on the win evaluation.

The application manager 126 administrates the operation and state of each software module. In addition, the application manager 126 administrates the configuration, progress and states of the game application program 92. The application manager 126 refers to a gaming state storage unit 127, determines the size of the symbol display area 64 based on the stored game state, and provides the game. The external communicator 128 communicates instructions and data with the system application program 98.

The credit balance manager module 104 executes a process for decrementing the credit balance according to the bet amount and incrementing the credit balance based on the total amount of winnings displayed on the winning meter. The pay table 130 includes a payout amount or award amount associated with each winning combination.

In an exemplary embodiment, the system application program 98 provides back ground processing and functions other than game specific functions. The system application program 98 includes a plurality of software modules including a system manager 142, a security manager 144, a slot management module 146, a denomination manager 148, a data logger 150, a communications manager 152, a bill acceptor manager 154, a metering module 156, and a cashout manager 158.

The system application program 98 may include a game recall file 160, an accounting log 162, and a meter 164. The system manager 142 is a software module for administrating all of the back-ground processing and functions other than game specific functions conducted by the system application program 98.

The security manager 144 is a software module for administrating game verification, door security and monitoring security sensors. The slot management module 146 is a software module for administrating data accumulation and communicating with an external slot information system.

The denomination manager 148 is a software module for establishing the denomination setting of the gaming machine 10. The denomination setting may include 1 cent, 2 cents, 5 cents, 25 cents, 1 dollar, 5 dollars and the like. The data logger 150 is a software module for logging the results of each game in a game recall. In addition, the data logger 150 stores error events, bill logs, cashout logs, ticket logs, and the like in an accounting log.

The game recall file 160 is an accumulated data including the results of each game. The game recall file 160 is stored in non-volatile memory. The accounting log 162 is an accumulated data including error events, bill logs, cashout logs, ticket logs and the like. The accounting log 162 is stored in non-volatile memory.

The communications manager 152 is a software module for administrating communication between the game application program 92 and the system application program 98. The communications manager 152 also administrates network communications between the system application program 98 and other the gaming machine 10, external network such as slot management system network, G2S network, gaming server for server-based gaming network or VLT system network.

The bill acceptor manager 154 is a software module for managing bill acceptors, and accepts bill information inserted in the bill acceptor. In response to receiving the information from the bill acceptor, the bill acceptor manager 154 communicates with the metering module to increment the credit balance based on the inserted bill.

The metering module 156 is a software module for adjusting the value of the meter 164 in response to communication with the game application program 92 via the communications manager 152, the bill acceptor manager 154 or the cashout manager 158. The meter 164 includes a credit meter to indicate the current credit balance of the gaming machine and a win meter to indicate the total amount of wins for the current gaming session. The meter further includes background meters, such as coin-in, coin-out, total drop, attendant paid jackpot and/or bill-in. These meters may be implemented as a data on non-volatile memory or hardware meters.

The cashout manager 158 is a software module for administrating a cashout procedure. In response to the player's operation on the cashout button, the cashout manager 158 is activated and the gaming machine pays the total amount of credit meters in cash or a voucher.

FIGS. 18 and 19 is flowchart for explaining the operation of the gaming machine. The algorithm (gaming method) of the operation of the gaming machine is implemented in the game application program 92 and is embodied by the CPU 38 executing the game application program 92. The operation of the gaming machine includes a plurality of steps. Each step may be performed independently or may be performed in combination with other steps.

In step S10, upon receiving a game start operation by the player and receiving an operation of the spin button from the player, the control unit 22 subtracts the set total bet amount from credit and acquires a predetermined number of random numbers required to provide the game. The random numbers are generated internally in the random number generator 108 in the control unit 22. The control unit 22 may acquire the random numbers from a random number generator provided separately from the control unit 22, or may acquire the random numbers from devices such as servers provided outside the gaming machine 10.

In step S12, the control unit 22 starts spinning of a plurality of reels. As a result, a plurality of symbols is displayed on the symbol display area 64, and the displayed symbols change. The control unit 22 stops spinning of the plurality of reels as step S14. Thus, the symbol combination is displayed on the symbol display area 64 as a game result.

In step S16, the control unit 22 determines whether the symbol combination displayed as the game result on the symbol display area 64 matches a winning combination. As an example, the control unit 22 determines a winning based on the symbol combination displayed in the symbol display area 64, the winning combination, and the set payline. When it is determined that there is a win (step S16: YES), the control unit 22 determines whether or not the symbol combination displayed as game result has triggered free game, as step S18.

When it is determined that the free game has been triggered (step S18: YES), the control unit 22 initializes a remaining number N of the free game as step S30. Here, the acquired number of times of the free game is the remaining number N of the free game.

In step S32, the control unit 22 initializes a multiplier value M of the multiplier. As an example, the initial value of the multiplier value M is twice. Next, in step S34, cumulative number (storing-up number) K of credit symbols is initialized. The control unit 22 sets a cumulative number K to zero.

In step S36, the control unit 22 subtracts one from the remaining number N of the free game. Next, in step S38, the control unit 22 acquires a predetermined number of random numbers. The processing contents of step S38 are the same as those of step S10. The control unit starts the spin of the plurality of reels as a step S40 and stops the spin of the plurality of reels as a step S42. The processing contents of steps S40 and S42 are the same as those of steps S12 and S14.

In step S44, the control unit 22 determines whether the symbol combination displayed as game result in the symbol display area 64 has a winning combination. The processing contents of step S44 are the same as those of step S16. When it is determined that the winning has occurred (step S44: YES), the control unit 22 provides the winning award to the player as step S46.

When it is determined that no winning has occurred (step S44: NO) or when the step S46 has ended, the control unit 22 determines whether a bonus event has occurred as step S48. As an example, the control unit 22 determines that the trigger condition of the bonus event is satisfied when the special symbol 85 is displayed by the virtual reel strip 72 in first reel in the symbol display area 64 and a credit symbol is displayed in at least one reel from second to fifth reels. When it is determined that the trigger condition of the bonus event is satisfied (step S48: YES), the control unit 22 increases the credit amount displayed in the credit symbol by M times and displays it as step S50. Then, the control unit 22 pays the total amount of the credit amount displayed in the credit symbol as step S52. Thereafter, the control unit 22 adds the number of credit symbols displayed on the symbol display area 64 to the cumulative number K.

In step S56, the control unit 22 determines whether the cumulative number K has reached the next rank. The control unit 22 refers to the multiplier value table 136 to determine if the cumulative number K has reached the next stage. When it is determined that the cumulative number K has reached the next stage (step S56: YES), the control unit 22 changes the multiplier value M of the multiplier to the next stage as step S58. The control unit 22 adds two times to the remaining number N of the free game as step S60.

When it is determined that the trigger condition of the bonus event is not satisfied (step S48: NO), when it is determined that the cumulative number K has not reached the next stage (step S56: NO), or when the step S60 is ended, the control unit 22 determines whether or not the remaining number N of the free game is zero as step S62.

When it is determined that the remaining number N of the free game is not zero (step S62: NO), the processing is executed again from step S36. Thus, the processing from steps S36 to S60 is repeatedly executed until the remaining number N of the free game becomes zero.

When it is determined that the free game has not been triggered (step S18: NO) or when it is determined that the remaining number N of the free game is zero (step S62: YES), the control unit 22 provides a winning award as step S20.

When it is determined that no winning has occurred (step S16: NO), or when step S20 has ended, the flowcharts shown in FIGS. 18 and 19 end.

By executing the flowcharts shown in FIGS. 18 and 19, the free game is continuously executed until the number of free games given to the player becomes zero, the bonus event award provided thereafter increases each time a predetermined number of credit symbols are accumulated, the increment of the bonus event award is maintained while the free game continues, and the increment of the bonus event award is reset (initialized) as the number of free games becomes zero.

As described above, in the gaming machine 10, by accumulating the number of occurrences of credit symbols, it is possible to provide a game in which it is easy to intuitively understand how the winning amount increases as the state of the game progresses. As a result, the gaming machine 10 can provide a new game that maintains or improves the player's interest.

The gaming machine 10 may be client computing devices, in which case the game is delivered from a network-server computer system to one or more client computing devices via a communication network. The processor of the client computing devices may be programmed to function as the control unit 22 of the gaming machine 10.

When the gaming machine 10 is used as a client computing device, 1) a rich client system may be used in which most of the processing involved in game execution is performed on the client side and results are transmitted to the server, 2) a thin-client system may be used in which only minimum processing is performed on the client side and main processing is performed on the server side, and 3) a zero client system may be used in which most of data storage and processing is performed on the server side and client specializes in input and output. In this case, the software configuration described in the embodiment is implemented and implemented in the client and the server.

In the above-described embodiment, a case has been described in which the virtual reel strips 72 to 80 are associated with each column of cells of the grid 68, however, it is also possible to associate an independent reel with each of the cells.

In the above-described embodiment, the control unit 22 may be a fixed value or may be determined at random from a predetermined range. In the case of being randomly determined from a predetermined range, the predetermined range may be shifted so as to include a large value according to the cumulative number of credit symbol, or the range may be expanded so as to include a large value.

In addition, the reel strips from second to fifth reels may be changed according to the symbols stopped and displayed in first reel. For example, when a special symbol stops in first reel, reel strips from second to fifth reels may be changed to a reel strip to which a credit symbol is added at a predetermined probability, or credit symbols having a size corresponding to a plurality of cells such as 2 rows×2 columns, 3 rows×3 columns, 4 rows×3 columns, or 4 rows×4 columns may be arranged from second to fifth reels so that a large number of wins occur at a time at a predetermined probability. For example, by using a reel strip in which special symbols are continuously arranged in first reel, a credit symbol having a size of 2 rows and 2 columns may appear in any of second to fifth reels when two special symbols are stopped and displayed, and a credit symbol having a size of 3 rows and 4 columns may appear in second to fifth reels when three special symbols are stopped and displayed. When the large symbol appears, the corresponding reel may be combined to arrange the large symbol, or the reel having the large symbol may be overlaid and displayed on the normal reel. By changing the screen and the winning probability as described above, it is possible to provide a novel game that continuously stimulates the player in various modes by more diversified game progress.

In the above-described embodiment, a case where a bonus event is applied to a free game has been described, however, a bonus event may be applied to a game provided in a cycle in which a plurality of games is one unit. In this case, credits may be collectively paid for games for one cycle, and games for one cycle may be continuously provided without intervention of a player's operation.

In the above-described embodiment, a case has been described in which the credit amount of the credit symbol displayed simultaneously with the special symbol 85 is acquired regardless of the display position. However, the credit amount may be provided when the special symbol and the credit symbol are line winning or when a predetermined positional relationship is satisfied. In addition, the credit amount assigned to the credit symbol may not always be displayed, and may be displayed after the reel stops.

In the above-described embodiment, an example in which a bonus event occurs in both of the normal game and the free game has been described. However, a bonus event may be generated in the free game instead of the normal game.

The function of the control unit 22 of the gaming machine 10 described above can also be realized by executing a program by a computer. That is, it is possible to create a program that causes one or more computers to function in the same manner as the control unit 22 described above. The program may be provided by being recorded in a computer-readable recording medium such as a ROM or a semiconductor memory. Such a program may be divided into a plurality of modules.

Additionally, various modifications can be made to the operation in each embodiment. For instance, a mode could be adopted where a necessary number of random numbers are acquired in advance to determine the reel stop positions. Once the winning of the special game and the determination of the presence or absence of winning are completed, the contents are sequentially displayed on the display. Moreover, for instance, the control unit 22 could collectively acquire a necessary number of random numbers at the start of the game. Each random number could then be stored in a storage area of the memory 42 or the storage 44, which is not erased even when there is a power source anomaly. In this scenario, even if a power failure or similar event occurs during the game, the control unit 22 can reproduce the game's progress. This is done by acquiring the random number, which was obtained at the start of the game before the power failure, from the memory 42 or the storage 44 when resuming the game after power restoration. For instance, if a power supply abnormality occurs just before the formation of a game result in which a high payout is obtained, a problem could arise if the same game does not proceed after power restoration. However, by collectively acquiring all random numbers at the start of the game and storing these numbers in the memory 42 or the storage 44 as described above, it is possible to reproduce the game's progress similar to that before the power source abnormality occurred, after power recovery. This way, such a problem can be avoided.

Additionally, in the described embodiment, a bill or a ticket represents the game value. The bill or ticket is received by the bill/ticket identification unit, and the ticket is output by the printer unit. However, the present disclosure is not limited to this setup. The game value concept includes tangible objects like coins, bills, medals, or tickets, as well as electronic data such as virtual credits or virtual currencies with equivalent value. For instance, a coin acceptor could accept coins and dispense coins from a coin hopper. One mode could involve identifying a player and using credits accumulated in a server account, with credits being paid out to the account. Alternatively, a mode could be adopted where credit information recorded on a storage medium like a magnetic card or an IC card is read and used, with credits being paid out by writing the information back to the storage medium. Furthermore, credits could be electronically transferred to and from a smartphone or a wearable device.

What is claimed is:

1. A gaming machine comprising:
an operation unit configured to receive an operation of a player;
a display unit configured to display symbols selected from a plurality of symbols including credit symbols each associated with a predetermined amount of award; and
a control unit connected to the operation unit and the display unit, configured to change and stop the symbols displayed by the display unit in response to receiving the operation of the player by the operation unit, and provide an award based on symbol arrangement formed by the symbols stopped in the display unit, wherein the control unit is configured to:
start a bonus event when the symbol arrangement includes at least one credit symbol and a predetermined condition is satisfied;
provide a bonus event award based on an amount associated with the at least one credit symbol occurred in the symbol arrangement;
accumulate the number of the credit symbols occurred in the bonus event; and
increase the bonus event award to be provided in subsequent game based on the number of credit symbols accumulated.

2. The gaming machine according to claim 1, wherein the plurality of symbols includes special symbols for using to satisfy the predetermined condition, and
the predetermined condition is that the symbol arrangement includes at least one special symbol.

3. The gaming machine according to claim 2, wherein the display unit partially displays a plurality of reels including the plurality of symbols and displays the symbols in cells arranged in a grid, and
the plurality of reels includes a reel including the special symbols and a reel including the credit symbols.

4. The gaming machine according to claim 1, wherein the control unit provides a plurality of free games that do not consume a game value when a trigger condition is satisfied in a normal game that consumes a game value, and provides predetermined number of free games to the player whenever predetermined number of credit symbols are accumulated in the free game.

5. The gaming machine according to claim 1, wherein the control unit increases the bonus event award each time predetermined number of credit symbols are accumulated, and provides the bonus event award in subsequent game.

6. The gaming machine according to claim 5, wherein the control unit increases the event award by applying a multiplier value to the amount associated with the at least one credit symbol occurred.

7. The gaming machine according to claim 6, wherein the control unit increases the multiplier value each time predetermined number of credit symbols are accumulated.

8. The gaming machine according to claim 6, wherein the control unit increases the multiplier value according to the number of credit symbols accumulated.

9. The gaming machine according to claim 1, wherein the control unit provides a plurality of free games that do not consume a game value when a trigger condition is satisfied in a normal game that consumes a game value, does not accumulate the number of credit symbols in response to occurrence of the event in the normal game, and accumulates the number of credit symbols in response to occurrence of the event in the free game.

10. The gaming machine according to claim 9, wherein the control unit executes the free game until remaining number of the free games provided to the player becomes zero, increases the bonus event award and remaining number of the free games each time predetermined number of credit symbols are accumulated, maintains an increase of the bonus event award during the free game, and resets the amount of the event award when the remaining number of the free games becomes zero.

11. The gaming machine according to claim 10, wherein the remaining number of the free games is increased whenever predetermined number of credit symbols are accumulated.

12. A gaming method for providing a game using a gaming machine, the gaming machine comprising:
an operation unit configured to receive an operation of a player;
a display unit configured to display symbols selected from a plurality of symbols including credit symbols each associated with a predetermined amount of award; and
a control unit connected to the operation unit and the display unit, configured to change and stop the symbols displayed by the display unit in response to receiving the operation of the player by the operation unit, and provide an award based on symbol arrangement formed by the symbols stopped in the display unit, the gaming method executed by the control unit, comprising:
starting a bonus event when the symbol arrangement includes at least one credit symbol and a predetermined condition is satisfied, and providing a bonus event award based on an amount associated with the at least one credit symbol occurred in the symbol arrangement; and
accumulating the number of the credit symbols occurred in the bonus event and increasing the bonus event award to be provided in subsequent game based on the number of credit symbols accumulated.

13. A non-transitory computer-readable storage medium storing a program for a gaming machine providing a game to a player, the gaming machine comprising:
an operation unit configured to receive an operation of a player;
a display unit configured to display symbols selected from a plurality of symbols including credit symbols each associated with a predetermined amount of award; and
a control unit connected to the operation unit and the display unit, configured to change and stop the symbols displayed by the display unit in response to receiving the operation of the player by the operation unit, and provide an award based on symbol arrangement formed by the symbols stopped in the display unit, the program configured to cause the control unit to:
start a bonus event when the symbol arrangement includes at least one credit symbol and a predetermined condition is satisfied, and provide a bonus event award based on an amount associated with the at least one credit symbol occurred in the symbol arrangement; and
accumulate the number of the credit symbols occurred in the bonus event and increase the bonus event award to be provided in subsequent game based on the number of credit symbols accumulated.
